(19) United States
(12) Patent Application Publication
(10) Pub. No.: US 2024/0417158 A1
(43) Pub. Date: Dec. 19, 2024

(54) CONTAINER FOR TRANSPORT OF ROOTED PLANT CUTTINGS

(71) Applicant: Rijoh Veredeling B.V., Delft (NL)

(72) Inventors: Paulus Marinus Maria ZWINKELS, Delft (NL); Andrew HAMILTON, Delft (NL)

(21) Appl. No.: 18/705,106

(22) PCT Filed: Oct. 20, 2022
(86) PCT No.: PCT/NL2022/050595

§ 371 Date: Apr. 26, 2024

(30) Foreign Application Priority Data
Nov. 3, 2021 (NL) 1044197

(51) Int. Cl. B65D 85/52; B65D 21/02; B65D 25/04

(52) U.S. Cl. CPC B65D 85/52; B65D 21/0209; B65D 25/04

(57) ABSTRACT

Container (1) for the transport of rooted plant cuttings (2), wherein the container comprises upright walls (3) which are made substantially of wood or rigid woody material. Grids (4) may be received between the walls, each grid being arranged to receive plant cuttings. The grids may also be made of wood or rigid woody material. The container is arranged and shaped so as to be stackable by form fit with similar containers. A loose base (5) is arranged and shaped so as to cooperate by form fit with the walls of the container.

The invention relates to a container designed and arranged for the transport of rooted plant cuttings.

The applicants are concerned with the production and transport of rooted plant cuttings from Africa. In this sector, usually cardboard boxes are used as packing for the transport of such rooted plant cuttings. Unfortunately, the shipments sometimes reach the Netherlands in very poor state: the cardboard boxes are often damaged, fall out of one another or collapse. In addition, on arrival, the plant cuttings are sometimes no longer neatly held in the grid intended for this, and slide around in the boxes. The problem of cardboard boxes is also that they are provided with a water-repellent wax which must offer protection against moisture. If the plant cuttings are watered and the cardboard becomes wet, the cardboard loses its rigidity. Providing the cardboard box with a water-repellent wax is an attempt to prevent this, but in many cases the boxes still collapse. An additional problem is that such wax-treated cardboard boxes cannot be disposed of as cardboard waste, but as paid landfill waste. As well as this cost, a high freight tariff is also applicable because the cardboard boxes are relatively heavy. Also, at present—and probably also in the future—cardboard is very difficult to obtain and expensive because of the enormous growth in mail order business.

The present invention proposes to offer a solution to the problems outlined above.

For this, according to the invention, a container is provided which is designed and arranged for the transport of rooted plant cuttings, wherein the container comprises upright walls which are made substantially of wood or rigid woody (ligneous) material, preferably certified wood from forestry, grown for example from pine wood. The wood can be cut up by the growers and milled and mixed into potting soil (loam), so there is no waste or disposal costs. This makes it a circular and environmentally friendly alternative which is also much more rigid and suitable for purpose.

The container is preferably arranged so as to be able to receive between its walls a grid or several grids one above the other, each grid being arranged to receive plant cuttings. The grid or several grids are preferably also made of wood or rigid woody material.

Preferably, the container is designed such that its walls are arranged and shaped so as to be stackable by form fit with similar containers, in particular the walls thereof.

The container according to the invention comprises a loose base which is arranged and shaped so as to cooperate by form fit with the walls of the container.

The container according to the invention—also described below as a plant tray—is made for example from thin solid wood or plywood, from wood which comes from local forestry.

By use of wood or woody material, a substantially more rigid container is obtained than by use of wax-treated cardboard boxes (see above). The containers according to the invention are lighter in weight than cardboard boxes, which brings the advantage of a lower freight tariff. In addition, the cuttings can be watered in the container without weakening the container. In contrast to cardboard, wood is more moisture-resistant.

Another advantage is that the grid is able to transport many plant cuttings per layer, for example three layers each with over 100 cuttings, which brings a loading advantage of around 50%. Because little air/space remains between the layers, the plant cuttings also remain neatly in place in the grid. Thus for example a plant robot can easily unpack the cuttings on arrival, which (see above) is not possible with a cardboard box in which the cuttings often slide around. This is thus a further important efficiency saving being achieved.

The invention will now be described in more detail with reference to the following description of the FIGURES.

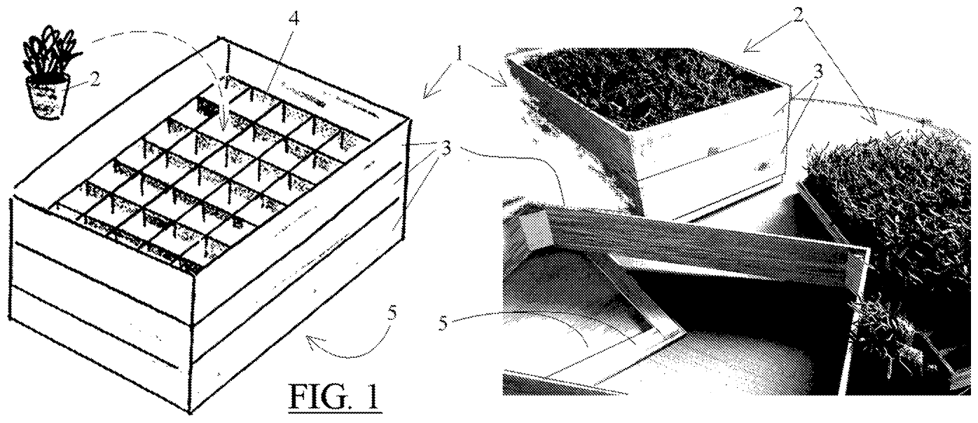

FIG. 1 shows an exemplary embodiment of a container according to the invention.

FIG. 1 shows an exemplary embodiment of a container 1 according to the invention, designed and arranged for the transport of rooted plant cuttings 2, wherein the container 1 comprises upright walls 3 which are substantially made of wood or rigid woody material.

The container 1 shown in FIG. 1 is arranged so as to be able to receive between its walls 3 a grid 4 or several grids 4 above one another, each grid 4 being arranged to receive plant cuttings 2 (in pots for example).

The grid 4 or several grids 4 are also made of wood or rigid woody material.

The container 1, in particular the walls 2 thereof, is arranged and shaped so as to be stackable by form fit with similar containers 1, in particular the walls 2 thereof: because the shapes of two containers 1 stacked on top of one another fit into one another (“form fit” or “form fit connection”; www.google.com/search?q=form+fit+connection), a firm stackability of the containers is achieved so that they cannot move around during transport.

The container 1 preferably comprises a loose base 5 which is arranged and designed to cooperate by form fit with the walls 3 of the container.

Thus the present invention provides a solution for the various problems outlined above with cardboard boxes, while providing a very environmentally friendly, easily reusable and (finally) recyclable product.

In the report on the prior art search which was carried out on 14 Jun. 2022, the examiner for his novelty objections refers to documents FR888854A of 24 Dec. 2042 (referred to below as ‘D1’) and GB01952A A.D. of 19 Sep. 2012 (‘D2’).

D1 discloses a growing or cultivating container which is designed and arranged for promoting and protecting the growth of the root ball and roots of plants (cuttings) for a relatively long time, for example so that the plants (cuttings) can be stored by the retailer or end user. For this, plants (cuttings) are planted in cylindrical tubes without base, whereby an open space exists in which the roots can grow. However, the container from D1 is not intended for stacking. On stacking of D1, the freshly sprouted or germinated plants become trapped or damaged, with the possible result of dead plants. The container shown in D1 is essentially a growing or cultivating container and not able to be transported in stacks when filled with plants (cuttings).

D2 describes a growing or cultivating container with a glass cover on the top side and drainage holes on the underside. These properties logically make the container unsuitable for stacked transport. If the containers from D2 are to be transported while filled with plants (cuttings), there is a risk that undesirably moisture and soil will reach the transport means through of the drainage holes on the underside of the container. This may be dangerous. In addition, because of the glass cover, D2 is not stackable, because this would block the incidence of light. D2 is designed and arranged as a long-term growing or cultivating container but is not suitable for stacked transport when filled with plants (cuttings).

Neither D1 nor D2 show a container with upright walls and a loose base which container is designed and arranged to cooperate by form fit with a similar container which can be stacked by placing on the top. Stacking of growing or cultivating containers from D1 and D2 is not possible. If the containers from D1 and D2 are stacked, during transport the stacks could easily fall over due to vibration and movement of the vehicle.

The examiner refers for inventiveness objections to WO 2009/116959A1 of 24 Sep. 2009 (‘D3’) and US 2007/137101A1 of 21 Jun. 2007 (‘D4’).

D3 discloses (plant) trays which can be stacked one above the other. However, stacking with D3 is not possible if the trays are filled with plants (cuttings). For transporting plants (cuttings), wherein the space of the transport means in the height must be utilized as efficiently as possible, the tray from D3 offers no solution, even in combination with the growing and cultivating containers from D1 and D2 intended for longer-term use, which are not originally designed and arranged for stacking. The average person skilled in the art and familiar with D1, D2 and D3 would not reach the invention without further inventive activity.

D4 discloses trays which are stackable even when the trays are filled with plants (cuttings), but the device from D4 is completely open. While transporting filled plant trays from D4, undesirably moisture and soil will reach the transport means. This may be dangerous. In addition, the open system from D4 exposes the plants (cuttings) to contamination by bacteria and insects from outside, to which young plant cuttings are especially susceptible. Also, on vibration or falling of the stacked trays, the plant cuttings may come out of the grid and reach the transport means. This is undesirable. D4 is therefore unsuitable as such for transport in a transport means.

The present invention offers a solution for the outlined problems of D3 and D4. In contrast to D3, according to the invention several layers with grids filled with plants (cuttings) can be transported stacked one above the other.

In contrast to D4, the plant cuttings according to the invention remain protected by the upright walls against contamination by bacteria and insects from the outside. The closed system according to the invention also ensures that, on vibration or falling of the stacked containers, the plant cuttings remain in their place in the grid.

1. A container, designed and arranged for the transport of rooted plant cuttings, wherein the container comprises upright walls which are made substantially of wood or rigid woody material.

2. The container as claimed in claim 1, wherein the container is arranged so as to be able to receive between its walls a grid or several grids one above the other, each grid being arranged to receive plant cuttings.

3. The container as claimed in claim 2, wherein the grid or several grids are also made of wood or rigid woody material.

4. The container as claimed in claim 1, wherein the container is arranged and shaped so as to be stackable by form fit with similar containers.

5. The container as claimed in claim 1, further comprising a loose base which is arranged and shaped so as to cooperate by form fit with the walls of the container.

6. The container as claimed in claim 4, wherein the walls are shaped to be stackable by form fit with similar containers.

7. The container as claimed in claim 2, further comprising a loose base which is arranged and shaped so as to cooperate by form fit with the walls of the container.

8. The container as claimed in claim 3, further comprising a loose base which is arranged and shaped so as to cooperate by form fit with the walls of the container.

9. The container as claimed in claim 1, in combination with a second, identical container in stacked form fit.
